(19) United States
(12) Patent Application Publication
(10) Pub. No.: US 2026/0165461 A1
(43) Pub. Date: Jun. 18, 2026

(54) ELECTRIC TOOTHBRUSH

(71) Applicant: CIXI SEAGO ELECTRONICS CO., LTD, Cixi (CN)

(72) Inventors: Yanzhong Cai, Cixi (CN); Zhuting Dong, Cixi (CN); Yuli Wang, Cixi (CN)

(21) Appl. No.: 19/315,650

(22) Filed: Aug. 31, 2025

(30) Foreign Application Priority Data
Dec. 16, 2024 (CN) 202411853481.0

(51) Int. Cl. A46B 15/00; A46B 5/00; A46B 13/02; A61C 17/22

(52) U.S. Cl. CPC A46B 15/0085; A46B 5/0095; A46B 13/02; A46B 15/0004; A46B 15/0038; A61C 17/222; A61C 17/225; A61C 2204/005

(57) ABSTRACT

The present disclosure relates to an electric toothbrush, including: a handle assembly including a measurement module; and a brush head assembly provided with a measured block to be identified. The brush head assembly is in contact with the handle assembly, and the measurement module is electrically connected to the measured block. A difference of the measured block forms a signal difference measured by the measurement module, and a type of a brush head is identified according to the signal difference. Thus, the electric toothbrush is capable of achieving the function of identifying the type of the brush head on the basis of reducing production costs and design costs.

### CROSS-REFERENCE TO RELATED APPLICATION

The present disclosure claims priority to Chinese patent application No. 202411853481.0, filed with the Chinese Patent Office on Dec. 16, 2024, the entire contents of which are incorporated herein by reference.

### TECHNICAL FIELD

The present disclosure relates to the field of toothbrushes, and in particular, to an electric toothbrush.

### BACKGROUND ART

Existing methods for identifying the type of brush head in existing electric toothbrushes mainly include: a magnetic field identification method, that is, embedding a magnet in the brush head, and detecting a magnetic field of the magnet in the brush head to identify the type of brush head when used in combination with a handle; and a near field communication (NFC) identification method, that is, embedding a data-containing NFC digital tag in the brush head, and reading information of the NFC digital tag in the brush head through an NFC wireless protocol to identify the type of brush head when used in combination with a handle.

However, in the magnetic field identification method, a magnet material embedded inside the electric toothbrush is prone to damage during production and use, and the production and design costs are high. In the NFC identification method, embedding the NFC digital tag in the brush head has a high production defect rate and the NFC digital tag is expensive, and an NFC chip and peripheral circuits need to be added to a handle end of the toothbrush, which increases the design cost of a printed circuit board (PCB) in the handle.

### SUMMARY

In view of this, the present disclosure proposes an electric toothbrush, which is capable of achieving the function of identifying a type of a brush head on the basis of reducing production costs and design costs.

According to an aspect of the present disclosure, an electric toothbrush is provided. The electric toothbrush comprises: a handle assembly comprising a measurement module; and a brush head assembly provided with a measured block to be identified. The brush head assembly is in contact with the handle assembly, and the measurement module is electrically connected to the measured block. A difference of the measured block forms a signal difference measured by the measurement module, and a type of a brush head is identified according to the signal difference.

In a possible implementation, the identification of the type of the brush head according to the signal difference specifically comprises: a digital signal output by the measurement module is configured to indicate a parameter of the measured block, and the parameter of the measured block is configured to indicate the type of the brush head of the brush head assembly.

In a possible implementation, the measurement module comprises: the measured block is a resistance module, and the parameter of the measured block comprises a resistance value of the measured block. The measurement module comprises a first access terminal for the measured block, a first reference resistor with a known resistance value, a voltage detector, and an analog-to-digital converter. The first access terminal for the measured block is connected in series with the first reference resistor. The first access terminal for the measured block is configured to connect the measured block in series with the first reference resistor when the brush head assembly is installed on the handle assembly. The voltage detector is configured to measure a voltage across the first reference resistor to obtain an analog voltage signal after the measured block is connected. The analog-to-digital converter is configured to convert the analog voltage signal into a digital voltage signal. The digital voltage signal is configured to indicate the resistance value of the measured block. The resistance value of the measured block is configured to indicate the type of the brush head of the brush head assembly. The digital signal comprises the digital voltage signal.

In a possible implementation, the measured block is a capacitance module, and the parameter of the measured block comprises a capacitance value of the measured block. The measurement module comprises a second access terminal for the measured block, a second reference resistor with a known resistance value, a reference capacitor with a known capacitance value, and a PWM generator. A first terminal of the second reference resistor is connected to an input voltage, a second terminal of the second reference resistor is connected in series with a first terminal of the reference capacitor, and a second terminal of the reference capacitor is grounded. The reference capacitor is connected in parallel with the second access terminal for the measured block, and the first terminal of the reference capacitor is connected to an input terminal of the PWM generator. The second access terminal for the measured block is configured to connect the measured block in parallel with the reference capacitor when the brush head assembly is installed on the handle assembly, so as to change a capacitance at the input terminal of the PWM generator. The capacitance at the input terminal of the PWM generator is configured to adjust a frequency of a PWM square wave signal output by the PWM generator. The PWM generator is configured to output a corresponding PWM square wave signal when the capacitance at the input terminal changes. The PWM square wave signal is configured to indicate the capacitance value of the measured block, and the capacitance value of the measured block is configured to indicate the type of the brush head of the brush head assembly. The digital signal comprises the PWM square wave signal.

In a possible implementation, the handle assembly comprises a spring-type contact module. The spring-type contact module is connected to an access terminal for the measured block in the measurement module. When the brush head assembly is installed on the handle assembly, the measured block in the brush head assembly is connected to the measurement module by contacting the spring-type contact module.

In a possible implementation, the measured block comprises a magnetic measured block. The handle assembly comprises a magnetic contact module. The magnetic contact module is connected to an access terminal for the measured block in the measurement module. The brush head assembly is attracted to the handle assembly through a magnetic force between the magnetic measured block and the magnetic contact module, and the magnetic measured block in the brush head assembly is connected to the measurement module by attracting the magnetic contact module.

In a possible implementation, the handle assembly further comprises a prompt module for sending prompt information. The prompt information is configured to indicate whether the brush head assembly and the handle assembly are successfully matched.

In a possible implementation, the prompt module is configured to send the prompt information through at least one of light, vibration, and sound.

In a possible implementation, the handle assembly further comprises a control module. The control module is configured to: receive the digital signal output by the measurement module, and determine the parameter of the measured block according to the digital signal; and determine an identification result of the brush head assembly according to the parameter of the measured block. The identification result characterizes whether the brush head assembly is matched with the handle assembly.

In a possible implementation, determining the identification result of the brush head assembly according to the parameter of the measured block comprises: determining whether the parameter of the measured block is within a preset parameter range, where the preset parameter range is configured to indicate a parameter range of the measured block in the brush head assembly matched with the handle assembly; determining that the brush head assembly is matched with the handle assembly in a case where the parameter of the measured block is within the preset parameter range; determining that the brush head assembly is not matched with the handle assembly in a case where the parameter of the measured block is not within the preset parameter range.

According to the embodiments of the present disclosure, by providing the measured block on the brush head assembly and the measurement module in the handle assembly, the measured block is capable of being electrically connected to the measurement module when the brush head assembly is in contact with the handle assembly. In this way, the signal difference measured by the measurement module may be formed through the difference of the measured block, so as to identify the type of the brush head according to the signal difference. Compared with the prior art in which the magnetic field identification technology or NFC identification technology is used to identify the type of the brush head, the electric toothbrush provided in the embodiments of the present disclosure does not require complex electronic elements or sensors, and thus has a relatively simple structure, is easy to implement, is not prone to damage, and may reduce production costs and design costs, thereby making it suitable for mass production.

Other features and aspects of the present disclosure will become clear from the detailed description of the exemplary embodiments with reference to the drawings below.

### BRIEF DESCRIPTION OF DRAWINGS

The drawings included in the description and forming a part of the description illustrate exemplary embodiments, features and aspects of the present disclosure together with the description, and are used to explain the principles of the present disclosure.

FIG. 1a shows a schematic diagram of an electric toothbrush according to an embodiment of the present disclosure.

FIG. 1b shows a sectional view of a brush head assembly according to an embodiment of the present disclosure.

FIG. 2a shows a schematic structural diagram of a measurement module according to an embodiment of the present disclosure.

FIG. 2b shows a schematic structural diagram of a measurement module to which a measured block is connected according to an embodiment of the present disclosure.

FIG. 3 shows a schematic structural diagram of another measurement module according to an embodiment of the present disclosure.

FIG. 4 shows a schematic structural diagram of a measurement module to which a measured block is connected according to an embodiment of the present disclosure.

FIG. 5 shows a schematic structural diagram of a PWM generator according to an embodiment of the present disclosure.

FIG. 6 shows a schematic structural diagram of another measurement module according to an embodiment of the present disclosure.

FIG. 7 shows a schematic structural diagram of a measurement module to which a measured block is connected according to an embodiment of the present disclosure.

FIG. 8 shows a block diagram of modules within a handle assembly according to an embodiment of the present disclosure.

### REFERENCE NUMERALS

10 represents handle assembly, 20 represents brush head assembly, Vin represents input voltage, ab represents access terminal for measured block, R0 represents first reference resistor, G represents voltage detector, ADC represents analog-to-digital converter, Rx represents resistance module, Cx represents capacitance module, R1 represents second reference resistor, C1 represents reference capacitor, GND represents ground terminal, and R10, R20 and R30 represent reference resistors respectively.

### DETAILED DESCRIPTION OF EMBODIMENTS

Various exemplary embodiments, features, and aspects of the present disclosure will be described in detail below with reference to the drawings. Same reference numerals in the drawings denote elements with same or similar functions. Although various aspects of the embodiments are shown in the drawings, the drawings are not necessarily drawn to scale unless specifically stated.

Herein, the term “exemplary” is used exclusively to mean “serving as an example, embodiment, or illustration”. Any embodiment described herein as “exemplary” should not be construed as superior to or better than other embodiments.

The term “and/or” herein is merely a term describing association relationships between associated objects, indicating three possible relationships. For example, A and/or B may mean that: A exists alone, both A and B exist, or B exists alone. Additionally, the term “at least one” herein indicates any one of a plurality of items or any combination of at least two of the plurality of items. For example, including at least one of A, B, and C may mean including any one or more elements selected from a set composed of A, B, and C.

It should be understood that the terms such as “first”, “second”, “third”, etc., in the claims, description, and drawings of the present disclosure are used to distinguish different objects rather than describe a specific order. The terms “include” and “comprise” used in the description and claims of the present disclosure indicate the presence of the described feature(s), whole(s), step(s), operation(s), element(s), and/or component(s), but do not exclude the presence or addition of one or more other features, wholes, steps, operations, elements, components, and/or their combinations.

Additionally, to better describe the present disclosure, numerous specific details are set forth in the following detailed description. Those skilled in the art should understand that the present disclosure can still be implemented without some specific details. In some examples, methods, means, elements, and circuits well known to those skilled in the art are not described in detail to highlight the gist of the present disclosure.

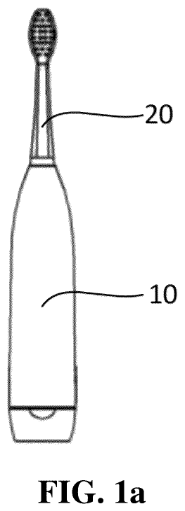

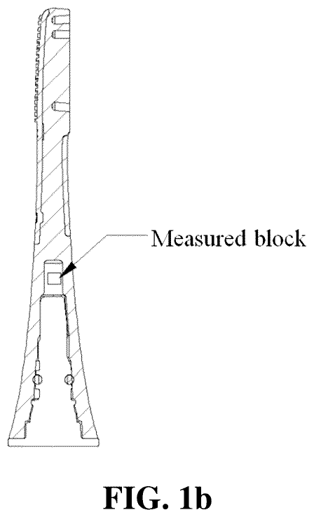

FIG. 1a shows a schematic diagram of an electric toothbrush according to an embodiment of the present disclosure. As shown in FIG. 1a, the electric toothbrush includes a handle assembly 10 and a brush head assembly 20. The brush head assembly 20 is provided with a measured block 201 to be identified (e.g., the measured block arranged in the brush head assembly shown in FIG. 1b). The handle assembly 10 includes a measurement module 101 (not shown in the figure).

The brush head assembly 20 is in contact with the handle assembly 10, and the measurement module 101 is electrically connected to the measured block 201. A difference of the measured block 201 forms a signal difference measured by the measurement module 101, and the type of a brush head is identified according to the signal difference.

It should be understood that when the brush head assembly 20 is installed on the handle assembly 10, the measured block 201 may be electrically connected to the measurement module 101. In this way, by changing an impedance such as a resistance or a capacitance in the measurement module 101, the measurement module 101 may output different digital signals. Different measured blocks enable the measurement module 101 to output different digital signals. That is, the difference of the measured block forms the signal difference measured by the measurement module 101, and thus the type of the brush head may be determined based on the signal difference.

The measured block includes a resistor, a capacitor, an inductor, a diode.

Digital circuits are constructed using logic gate circuits combined with diodes and triodes to identify different brush heads.

A diode has a unidirectional conductivity, and may be used to perform basic logic operations, such as “AND” and “OR” operations. The diode may act as a switch in a circuit, allowing current to pass through or blocking current.

A triode is generally used for signal amplification or used as a switch, NPN type and PNP types triodes are common. The triode is generally used to implement logic gates in a digital circuit, such as an “AND gate”, an “OR gate”, and a “NOT gate”, etc.

### Logic Gates:

Different logic gate combinations may be achieved using diodes and triodes, such as an “AND gate”, an “OR gate”, a “NAND gate”, a “NOR gate”, etc.

In schemes for identifying different brush heads, there are a plurality of brush heads, and a state of each brush head (such as on/off, different voltage or signal inputs) may be represented as an input signal. Through appropriate logic circuits, a circuit is designed to determine which brush head is selected.

For example, there are three brush head schemes, which respectively correspond to signals A, B, and C. If a brush head A is selected, an input signal A is at a high level (1), and other signals are at a low level (0).

The AND gate is used to determine whether specific conditions are met (e.g., all inputs are at a high level).

The OR gate is used to determine whether any of the input signals is at a high level.

The NOT gate is used to invert states of certain input signals.

By combining these logic gates, the selection and identification of brush heads may be achieved.

In a specific example, to determine whether the brush head A is selected, assume that the input signal of the brush head A is A, and the input signals of other brush heads are B and C, respectively.

A simple circuit is A AND NOT B AND NOT C, where an output is at a high level only when the brush head A is selected.

As described above, the measurement module 101 may be electrically connected to the measured block 201 and output a digital signal. That is, the measurement module 101 may output the digital signal when the measured block 201 is connected to the measurement module 101. Therefore, the identification of the type of the brush head according to the signal difference specifically includes: the digital signal output by the measurement module 101 is used to indicate a parameter of the measured block 201, and the parameter of the measured block 201 is used to indicate the type of the brush head of the brush head assembly 20. The parameter of the measured block 201 may include a resistance value, a capacitance value, etc., of the measured block 201.

A connection between the brush head assembly 20 and the handle assembly 10 is a detachable connection, that is, the brush head assembly 20 is capable of being detachably (i.e., separably) installed on the handle assembly 10. It should be understood that the handle assembly 10 may be matched with a plurality of types of brush head assemblies 20, and the brush head assembly 20 installed on the handle assembly 10 may be frequently replaced. Therefore, the handle assembly 10 needs to identify the type of the brush head of the installed brush head assembly 20 to determine whether the brush head assembly 20 is matched with the handle assembly 10.

In practical applications, measured blocks having different parameters may be respectively arranged in different types of brush head assemblies, so that the parameters of the different measured blocks are respectively used to indicate the different types of brush head assemblies. A resistance module or a capacitance module may be used as the measured block. For example, a metal block may be specifically used as the resistance module. A capacitor component may be specifically used as the capacitance module. Thus, the parameters of the measured blocks may include the resistance value and/or the capacitance value. It should be understood that those skilled in the art may select any known measured blocks with impedance characteristics according to actual needs, and design a parameter, a type, and a size of a measured block in a different type of brush head assembly and a position of the measured block in this brush head assembly (such as the position of the measured block in FIG. 1b, or the measured block may be located at a bottom or a side of the brush head assembly), as long as the required functions are capable of being achieved, which is not limited in the embodiments of the present disclosure.

It should be understood that the electric toothbrush shown in FIG. 1a is an exemplary implementation provided in the present disclosure. In practice, those skilled in the art may design external dimensions and an internal structure of the electric toothbrush according to actual needs. For example, the handle assembly 10 may also be provided with a power module to supply a power supply voltage to other module (such as the measurement module), and the power module may further be used for wireless or wired charging. The handle assembly 10 may also be provided with a vibration motor to drive the brush head assembly 20 to vibrate, as well as various switch buttons to start or stop the electric toothbrush or to switch brushing modes, etc., which is not limited in the embodiments of the present disclosure.

The measurement module may be understood as a circuit module. When the measured block is electrically connected to the measurement module, it is equivalent to connecting a resistor and/or capacitor to the measurement module. In a case where a power supply voltage input to the measurement module is constant, the measured block connected to the measurement module changes an impedance of the measurement module, thereby resulting in a change in the digital signal output by the measurement module. By measuring the changed digital signal (i.e., the signal difference), the parameter of the measured block may be indicated, and the parameter of the measured block may be used to indicate the type of the brush head of the brush head assembly.

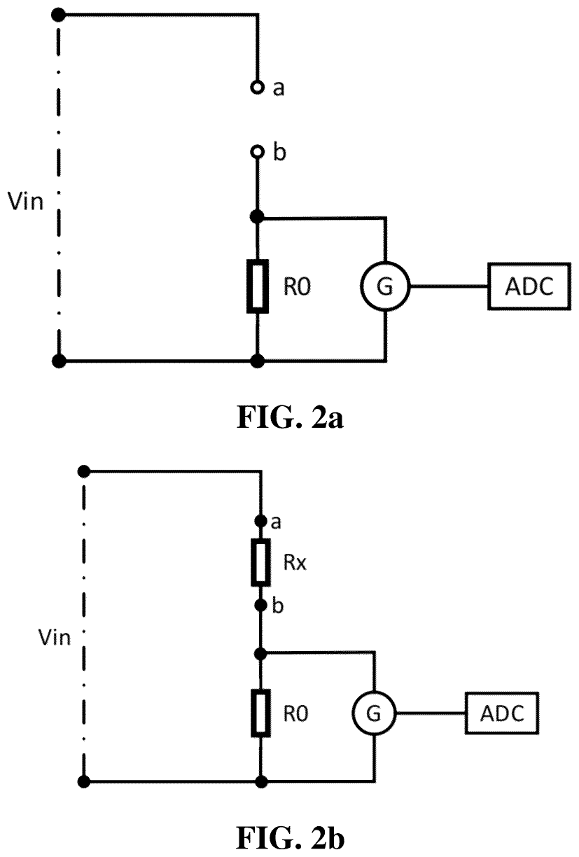

As described above, the measured block may be the resistance module, and the parameter of the measured block may include the resistance value of the measured block. Optionally, FIG. 2a shows a schematic structural diagram of a measurement module according to an embodiment of the present disclosure, as shown in FIG. 2a, the measurement module 101 may include a first access terminal (ab terminal) for the measured block, a first reference resistor (R0) with a known resistance value, a voltage detector (G), and an analog-to-digital converter (ADC). The first access terminal (ab terminal) for the measured block is connected in series with the first reference resistor (R0).

The first access terminal (ab terminal) for the measured block is used to connect the measured block 201 in series with the first reference resistor (R0) when the brush head assembly 02 is installed on the handle assembly 01.

The voltage detector (G) is used to measure a voltage across the first reference resistor (R0) to obtain an analog voltage signal after the measured block 201 is connected.

The analog-to-digital converter (ADC) is used to convert the analog voltage signal into a digital voltage signal. The digital voltage signal is used to indicate the resistance value of the measured block, and the resistance value of the measured block is used to indicate the type of the brush head of the brush head assembly. The digital signal includes the digital voltage signal.

Exemplarily, based on the measurement module shown in FIG. 2a, after the brush head assembly 02 is installed on the handle assembly 01, for example, the schematic structural diagram of the measurement module to which the measured block 201 is connected shown in FIG. 2b may be obtained, where Rx represents the connected resistance module (measured block 201). As shown in FIG. 2b, an input voltage Vin is constant, and when the resistance module (Rx) is connected to the measurement module 101 shown in FIG. 2a, the input voltage Vin passes through a series circuit formed by the first reference resistor (R0) and the resistance module (Rx). At this time, the voltage across the first reference resistor (R0) changes, and the voltage detector (G) connected in parallel with the first reference resistor (R0) is capable of measuring the changed voltage across the first reference resistor (R0), so as to obtain the analog voltage signal after the resistance module (Rx) is connected. Then, the analog-to-digital converter (ADC) may convert the analog voltage signal into the digital voltage signal, and the digital voltage signal may indicate a voltage value Vout across the first reference resistor (R0) after the measured block 201 is connected. According to the Ohm's law “voltage=current×resistance” and the voltage division principle of the series circuit, it can be known that there is a linear relationship between the voltage value Vout of the first reference resistor (R0) and the resistance value of the measured block 201 (i.e., the resistance value of Rx). Therefore, the above digital voltage signal may also be used to indicate the resistance value of the measured block.

In practical applications, the resistance value of the measured block may also be calculated based on the measured digital voltage signal. Specifically, knowing the input voltage Vin, the resistance value of the first reference resistor (R0), and the measured voltage value Vout, according to Ohm's law “voltage=current×resistance” and the voltage division principle of the series circuit, Vin=I×(R0+Rx), and Vout=I×R0 may be obtained, and thus I=Vout/R0, and Rx=(Vin−Vout)/I may be derived. By substituting I=Vout/R0 into Rx=(Vin−Vout)/I, Rx=(Vin−Vout)/(Vout/R0)=R0×(Vin/Vout−1) may be obtained, that is, the resistance value of Rx is calculated, thereby achieving the identification of the type of the brush head.

In practical applications, a general-purpose voltage detector may be used as the above voltage detector, or a current detector may be combined with a sampling resistor to form the voltage detector. Based on this, the current detector may be connected in series with the first reference resistor (R0). When the measured block 201 is connected to the measurement module 101, the first reference resistor (R0) and the resistance module (Rx) form the series circuit, and then the current detector may be used to measure a current through the first reference resistor (R0) after the measured block 201 is connected, so as to obtain an analog current signal. The analog current signal is converted into an analog voltage signal through the sampling resistor, and then the analog voltage signal is converted into the digital voltage signal through the analog-to-digital converter (ADC). Thus, the resistance value of the measured block is calculated using the digital voltage signal. Since the input voltage Vin is constant, similarly, according to Ohm's law “voltage=current×resistance” and the voltage division principle of the series circuit, it can be known that there is a linear relationship between the voltage value of the first reference resistor (R0) and the resistance value of the measured block 201 (i.e., the resistance value of Rx). Thus, the resistance value of the measured block 201 may be calculated by referring to the above implementation method for calculating the resistance value of the measured block based on the digital voltage signal.

It should be understood that those skilled in the art may use known electrical components such as reference resistors, voltage detectors, and analog-to-digital converters to establish the measurement module shown in FIG. 2a. The measurement module shown in FIG. 2a is only an exemplary implementation provided in the embodiments of the present disclosure. In practice, under the inspiration of the measurement module shown in FIG. 2a, those skilled in the art may custom-design a specific circuit structure of the measurement module. For example, other required electrical components may be added based on the measurement module shown in FIG. 2a, which is not limited in the embodiments of the present disclosure.

For example, the measurement module may also be provided with a low dropout regulator (LDO). An input terminal in and an output terminal out of the LDO are respectively connected to two capacitors (e.g., 10 μF capacitors may be used), and a ground terminal GND is grounded. The LDO regulator is capable of converting an input higher power supply voltage VCC into a stable input voltage Vin (such as 3.3V), so that a lower input voltage Vin may be applied to the resistance module (Rx) and the first reference resistor (R0) connected in series, thereby avoiding damage to other components in the circuit.

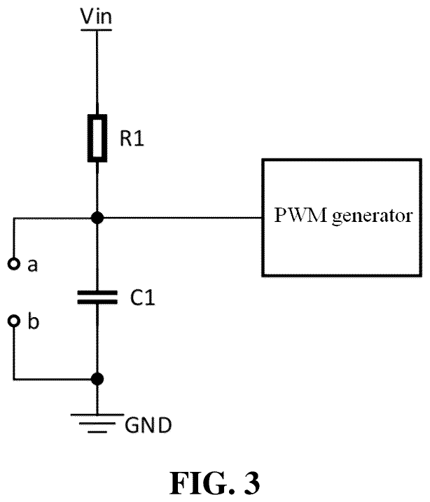

As described above, the measured block may be the capacitance module, and the parameter of the measured block may include the capacitance value. Optionally, FIG. 3 shows a schematic structural diagram of another measurement module according to an embodiment of the present disclosure, as shown in FIG. 3, the measurement module 101 may include:
a second access terminal (ab terminal) for the measured block, a second reference resistor (R1) with a known resistance value, a reference capacitor (C1) with a known capacitance value, and a PWM generator. A first terminal of the second reference resistor (R1) is connected to the input voltage Vin, a second terminal of the second reference resistor (R1) is connected in series with a first terminal of the reference capacitor (C1), and a second terminal of the reference capacitor (C1) is grounded (GND). The reference capacitor (C1) is connected in parallel with the second access terminal (ab terminal) for the measured block, and the first terminal of the reference capacitor (C1) is connected to an input terminal of the PWM generator.

The second access terminal (ab terminal) for the measured block is used to connect the measured block 201 in parallel with the reference capacitor (C1) when the brush head assembly 02 is installed on the handle assembly 01, so as to change a capacitance at the input terminal of the PWM generator. The capacitance at the input terminal of the PWM generator is used to adjust a frequency of a PWM square wave signal output by the PWM generator.

The PWM generator is used to output a corresponding PWM square wave signal when the capacitance at the input terminal changes. The PWM square wave signal is used to indicate the capacitance value of the measured block, and the capacitance value of the measured block is used to indicate the type of the brush head of the brush head assembly. The digital signal includes the PWM square wave signal.

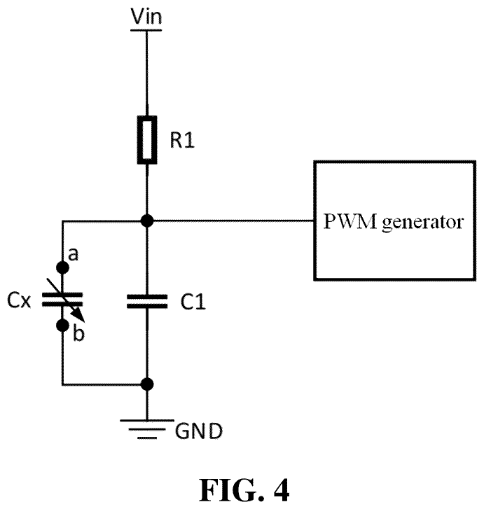

Based on the measurement module shown in FIG. 3, after the brush head assembly 02 is installed on the handle assembly 01, for example, the schematic structural diagram of the measurement module to which the measured block 201 is connected as shown in FIG. 4 may be obtained, where Cx represents the connected capacitance module (measured block 201). As shown in FIG. 4, an input voltage Vin is constant, and when the measured block 201 is connected to the measurement module 101 shown in FIG. 3, the capacitance module (Cx) and the reference capacitor (C1) form a parallel circuit. At this time, the capacitance at the input terminal of the PWM generator changes, so that the frequency of the PWM square wave signal output by the PWM generator changes. There is a certain linear mapping relationship between the frequency of the PWM square wave signal output by the PWM generator and the capacitance at the input terminal of the PWM generator. Therefore, the changed frequency may be obtained by counting waveforms of the PWM square wave signal, and the capacitance value of the measured block 201 may be obtained based on a pre-established linear mapping relationship. Therefore, the above PWM square wave signal may be used to indicate the capacitance value of the measured block.

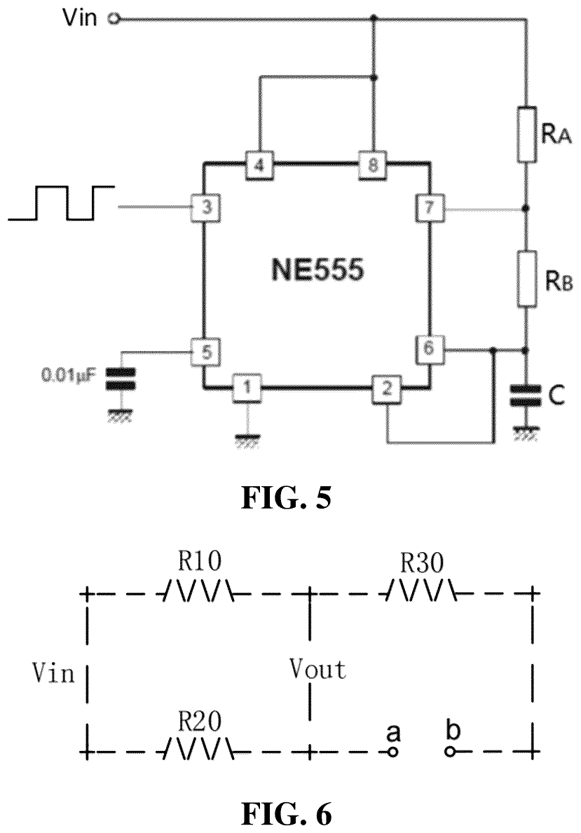

A known generator for producing pulse width modulation (PWM) square wave signals in the art may be used as the PWM generator. For example, an NE555 chip may be used, a clock is an external RC clock, and the square wave signal is output from port 3. As shown in FIG. 5, the NE555 chip may automatically trigger the output of the square wave signal in an astable mode, and a frequency of an output square wave signal may be adjusted by a capacitance (i.e., a magnitude of C) at an input terminal (i.e., port 6) and resistors RA and RB. The above second reference resistor (R1) may be split into RA and RB, that is, resistance values of RA and RB are known. The frequency of the square wave signal is f=1.44/(RA*C+2RB*C). Based on this, the first terminal of the reference capacitor (C1) may be connected to port 6 of the NE555 chip, and the capacitance input to port 6 is C=C1+Cx. After Cx is connected to the measurement module, the frequency of the PWM square wave signal output by the NE555 chip changes. The changed frequency is obtained by counting the waveforms of the PWM square wave signal, and the changed frequency is substituted into the above formula f=1.44/(RA*C+2RB*C), and the capacitance value of C1 is known, then the capacitance value of Cx may be calculated based on C=C1+Cx, that is, the capacitance value of the measured block may be obtained.

It should be understood that using the NE555 chip as the PWM generator is a possible implementation provided in the embodiments of the present disclosure. In practice, under the inspiration of the embodiments of the present disclosure, those skilled in the art may use other known electronic component with functions similar to the NE555 chip as the PWM generator, which is not limited in the embodiments of the present disclosure.

Optionally, FIG. 6 shows a schematic structural diagram of another measurement module according to an embodiment of the present disclosure, as shown in FIG. 6, the measurement module 101 may include:
a third access terminal (ab terminal) for the measured block, a reference resistor (R10) with a known resistance value, a reference resistor (R20) with a known resistance value, a reference resistor (R30) with a known resistance value, a voltage detector G (not shown in the figure), an operational amplifier (OPA) (not shown in the figure), and an analog-to-digital converter (ADC) (not shown in the figure). The third access terminal (ab terminal) for the measured block is connected to the reference resistor (R10), the reference resistor (R20), and the reference resistor (R30) to form a Wheatstone bridge.

The third access terminal (ab terminal) for the measured block is used to connect the measured block 201 to the reference resistor (R10), the reference resistor (R20), and the reference resistor (R30) to form the Wheatstone bridge when the brush head assembly 02 is installed on the handle assembly 01.

The voltage detector (G) is used to measure a bridge voltage Vout output by the Wheatstone bridge to obtain an initial analog voltage signal after the measured block 201 is connected.

The operational amplifier (OPA) is used to amplify the initial analog voltage signal to obtain a target analog voltage signal.

The analog-to-digital converter (ADC) is used to convert the target analog voltage signal into a digital voltage signal.

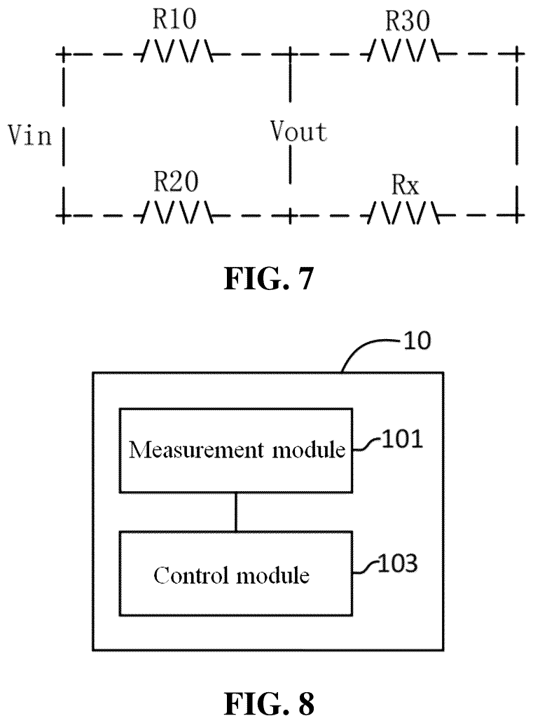

Based on the measurement module shown in FIG. 6, when the brush head assembly 02 is installed on the handle assembly 01, for example, the schematic structural diagram of the measurement module to which the measured block 201 is connected shown in FIG. 7 may be obtained, where Rx represents the connected resistance module (measured block 201). As shown in FIG. 7, an input voltage Vin is constant, and when the measured block 201 is connected to the measurement module 101 shown in FIG. 6, Rx, R10, R20, and R30 are connected to form the Wheatstone bridge. It should be understood that when the brush head assembly 02 is not installed (i.e., the measured block 201 is not connected), the access terminal (ab terminal) for the measured block in the Wheatstone bridge is empty or infinite (open circuit). At this time, the Wheatstone bridge is unbalanced, and the bridge voltage Vout output by the voltage detector (G) is not zero. The specific voltage value depends on the resistance values of R10, R20, R30, and a state of Rx. When the brush head assembly 02 is installed (i.e., the measured block 201 is connected), a specific Rx is added to the Wheatstone bridge, which affects a balance state of the Wheatstone bridge. The Rx after the measured block 201 is connected may cause the Wheatstone bridge to change from an unbalanced state to a new balanced state, or to continue to maintain the unbalanced state, but the bridge voltage Vout output by the voltage detector (G) changes, that is, the initial analog voltage signal after the measured block 201 is connected is obtained. Then, the operational amplifier (OPA) amplifies the initial analog voltage signal, and the analog-to-digital converter (ADC) converts the amplified target analog voltage signal into the digital voltage signal. Since there is a certain functional relationship between the bridge voltage Vout in the Wheatstone bridge and Rx, the above digital voltage signal may be used to indicate the resistance value of the measured block 201.

In practical applications, the functional relationship between the bridge voltage Vout and Rx may be pre-established. When the digital voltage signal Vout after the measured block 201 is connected is measured, the resistance value corresponding to the measured block 201 (i.e., a value of Rx) may be calculated by combining the above pre-established functional relationship, thereby achieving the identification of the type of the brush head.

It should be understood that those skilled in the art may use known electrical components such as the first reference resistor, the second reference resistor, the third reference resistor, the voltage detector (such as a galvanometer), the operational amplifier, and the analog-to-digital converter to establish the above measurement module. The above measurement module is only an exemplary implementation provided in the embodiments of the present disclosure. In practice, under the inspiration of the above measurement module, those skilled in the art may custom-design a specific circuit structure of the measurement module. For example, other required electrical components may be added based on the measurement module, which is not limited in the embodiments of the present disclosure.

Based on any of the measurement modules shown in FIGS. 2a to 7, those skilled in the art may custom-set an access method of the measured block 201 into the measurement module 101, as long as the measured block 201 may be connected to the measurement module through the access terminal for the measured block, which is not limited in the embodiments of the present disclosure.

Optionally, the handle assembly 10 includes a spring-type contact module, and the spring-type contact module is connected to the access terminal (ab terminal) for the measured block in the measurement module 101. When the brush head assembly 20 is installed on the handle assembly 10, the measured block 201 in the brush head assembly 20 is connected to the measurement module 101 by contacting the spring-type contact module. It should be understood that the spring-type contact module may include a plurality of spring-type contacts to increase a contact area with the measured block, so as to better connect the measured block. In a case where the spring-type contact module 102 is connected to the measured block 201 and the access terminal (ab terminal) for the measured block in the measurement module 101, since the measured block 201 is conductive, when the brush head assembly 20 is installed on the handle assembly 10 (such as inserted into the handle assembly 10), the measured block 201 on the brush head assembly 20 contacts the spring-type contact module 102 on the handle assembly 10, and the spring-type contact module 102 is capable of automatically connecting the measured block 201 to the measurement module 101.

Optionally, the measured block 201 includes a magnetic measured block (metal block). The handle assembly 10 includes a magnetic contact module, and the magnetic contact module is connected to the access terminal for the measured block in the measurement module 101. The brush head assembly 20 is attracted to the handle assembly 10 by a magnetic force between the magnetic metal block and the magnetic contact module, and the magnetic metal block in the brush head assembly 20 is connected to the measurement module 101 by attracting the magnetic contact module. The magnetic metal block may be a metal block made of a magnetic metal material or a metal block containing a magnetic material, which is not limited in the embodiments of the present disclosure. The magnetic contact module may include a plurality of magnetic contacts to increase a contact area with the measured block, so as to better connect and attract the measured block.

It should be understood that by using the magnetic contact module on the handle assembly 10, the brush head assembly 10 is capable of being firmly attracted to the handle assembly 20 through the magnetic force while an electrical connection is achieved. When the brush head assembly 20 is getting close to the handle assembly 10, the magnetic contact module firmly attracts the brush head assembly 20 to ensure that the magnetic metal block in the brush head assembly 20 is connected to the magnetic contact module. Since the magnetic contact module is connected to the access terminal for the measured block in the measurement module 101, the metal block 201 is connected to the measurement module 101. This method ensures a reliable electrical connection, and enables the measured block to be correctly connected to the measurement module 101. It should be understood that in FIG. 8 above, 102 may indicate the magnetic contact module, and 201 may indicate the magnetic metal block, which may also achieve the connection of the measured block 201 to the measurement module 101.

In practical applications, when the brush head assembly 20 is installed on the brush handle assembly 10, the measured block 201 in the brush head assembly 10 changes the digital signal (such as the digital voltage signal or the PWM square wave signal) output by the measurement module 101 in the brush handle assembly 10. After the digital signal changes, the changed digital signal may be transmitted to a control module of the electric toothbrush, and the control module may identify the type of the brush head assembly by analyzing the change of the digital signal. After the type of the brush head assembly is identified, it can also be determined whether the brush head assembly is matched with the handle assembly based on the type of the brush head assembly. Whether the brush head assembly is matched with the handle assembly may include whether the type of the brush head assembly (i.e., a model of the brush head) is matched with the handle assembly, or whether the brush head assembly is correctly installed on the handle assembly. It should be understood that if the brush head assembly is not correctly installed on the handle assembly, the measured parameter of the measured block is most likely not an actual parameter, and in this case, a type of the brush head assembly characterized by this parameter is most likely not the type matched with the handle assembly.

Thus, in a possible implementation, as shown in the block diagram of modules within the handle assembly 10 in FIG. 8, the handle assembly 10 may further include the control module 103. The control module 103 is used to:
receive the digital signal output by the measurement module 101, and determine the parameter of the measured block 201 according to the digital signal; and
determine an identification result of the brush head assembly 20 according to the parameter of the measured block 201. The identification result characterizes whether the brush head assembly 20 is matched with the handle assembly 10.

The control module 103 may be implemented by a dedicated hardware circuit, or by a general-purpose processing hardware (such as a central processing unit CPU, a single-chip microcomputer, a field-programmable gate array FPGA, a controller, a microcontroller MCU, a microprocessor MPU) combined with executable logic instructions, so as to execute a working process of the control module 103. The executable logic instructions may be implemented based on existing technical means. The specific implementation of the control module 103 is not limited in the embodiments of the present disclosure.

As above, the measurement module 101 has a plurality of implementations. For a different measurement module 101, a corresponding calculation method may be used to determine the parameter (such as the resistance value or the capacitance value) of the measured block 201 according to the digital signal. For example, the resistance value Rx of the measured block 201 is determined according to a digital current signal Iout, or the capacitance value Cx of the measured block is determined according to the frequency of the PWM square wave signal. As described above, for the measurement module shown in FIG. 2a, the resistance value of the measured block 201 may be calculated by using Rx=R0×(Vin/Vout−1). For the measurement module shown in FIG. 3, the capacitance value of the measured block 201 may be determined based on the linear mapping relationship between the frequency of the PWM square wave signal output by the PWM generator and the capacitance at the input terminal of the PWM generator. Alternatively, when the NE555 chip is used as the PWM generator, the capacitance value of the measured block 201 is calculated by using f=1.44/(RA*C+2RB*C), which is not limited in the embodiments of the present disclosure.

In practical applications, since the parameter (i.e., the resistance value or the capacitance value) of the measured block 201 may indicate the type of the brush head of the brush head assembly 20, whether the brush head assembly 20 is matched with the handle assembly 10 may be determined based on the parameter of the measured block 201. Specifically, in a possible implementation, determining the identification result of the brush head assembly according to the parameter of the measured block may include: determining whether the parameter of the measured block is within a preset parameter range, where the preset parameter range is used to indicate a parameter range of the measured block in the brush head assembly matched with the handle assembly; determining that the brush head assembly is matched with the handle assembly in a case where the parameter of the measured block is within the preset parameter range; determining that the brush head assembly is not matched with the handle assembly in a case where the parameter of the measured block is not within the preset parameter range.

It should be understood that during the design of the electric toothbrush, measured blocks with a same parameter may be respectively used in a same type of brush head assemblies. Due to a manufacturing error of the measured block, the same parameter of the measured blocks has an error range. For example, a batch of measured blocks with a resistance value of 5 ohms (Ω) may have an error of ±1Ω, and the measured block 201 also has a resistance error when connected to the measurement module 101 (such as a resistance error caused by a positional deviation between the measured block 201 and the contact during use). Therefore, the resistance value Rx of the measured block 201 in each type of brush head assemblies may be set with a preset resistance range. Similarly, the capacitance value Cx of the measured block 201 may be set with a preset capacitance range. The preset parameter range may include a preset resistance range and a preset capacitance range. A preset parameter range corresponding to a different handle assembly 20 may be determined according to a design parameter of the measured block in the brush head assembly, and may be stored in the control module 103 of the handle assembly 10. That is, the handle assembly 10 may store the parameter range of the measured block in the brush head assembly matched with the handle assembly 10. The preset parameter range may have a certain tolerance to allow minor variations in manufacturing and use.

In practical applications, when the brush head assembly 20 is installed on the handle assembly 10, the measured block 201 in the brush head assembly 20 causes the change in the digital signal output by the measurement module 101. The changed digital signal is transmitted to the control module 103. The control module 103 calculates the parameter of the measured block in the brush head assembly based on the digital signal, and compares the measured parameter with the preset parameter range. If the measured parameter is within the preset parameter range, it indicates that the brush head assembly is correctly installed and the type of the brush head is successfully matched, that is, the brush head assembly is matched with the handle assembly. If the measured parameter is not within the preset parameter range, it indicates that the brush head assembly may not be correctly installed or the type of the brush head is not matched, that is, the brush head assembly is not matched with the handle assembly.

To facilitate users to know whether the brush head assembly and the handle assembly are successfully matched, a corresponding prompt may further be sent to users through at least one of light, vibration, or sound based on the identification result. For example, after successful matching, that is, after detecting that the brush head assembly is correctly installed and the type of the brush head is matched, the electric toothbrush may prompt users through light, vibration, or sound that the brush head has been successfully matched.

Thus, in a possible implementation, the handle assembly 10 may further include a prompt module 104 for sending prompt information. The prompt information is used to indicate whether the brush head assembly and the handle assembly are successfully matched. Specifically, the prompt module 104 may send the prompt information through at least one of light, vibration, and sound. Alternatively, the above prompt information may also be sent to a user by sending a reminder to a smart terminal used by the user. It should be understood that for different identification results, different prompt methods may be used, and those skilled in the art may customize a prompt method corresponding to a different identification result, which is not limited in the embodiments of the present disclosure. Prompting users whether the brush head assembly is matched with the handle assembly through light, vibration, or sound enhances the user experience and avoids the problems caused by improper brush head installation or mismatched brush heads.

In practical applications, the control module 103 may control the prompt module 104 to send the prompt information after obtaining the identification result. For example, the prompt module 104 may include at least one of an indicator light, a vibration motor, and a speaker. The control module 103 may control the indicator light to send a light prompt, control the vibration motor to send a vibration prompt, or control the speaker to send a sound prompt, which is not limited in the embodiments of the present disclosure. It should be understood that those skilled in the art may design the specific structure of the prompt module 104 by using known electrical components in the art, as long as the required functions are capable of being achieved, which is not limited in the embodiments of the present disclosure.

According to the electric toothbrush in the embodiments of the present disclosure, by providing the measured block on the brush head assembly and the measurement module in the handle assembly, the measured block is capable of being electrically connected to the measurement module when the brush head assembly is in contact with the handle assembly. In this way, the signal difference measured by the measurement module may be formed through the difference of the measured block, so as to identify the type of the brush head according to the signal difference. Compared with the prior art in which the magnetic field identification technology or NFC identification technology is used to identify the type of the brush head, the electric toothbrush provided in the embodiments of the present disclosure does not require complex electronic elements or sensors, and thus has a relatively simple structure, is easy to implement, is not prone to damage, and may reduce production costs and design costs, thereby making it suitable for mass production.

The embodiments of the present disclosure are described above. The foregoing description is exemplary, not exhaustive, and is not limited to the disclosed embodiments. Many modifications and variations are apparent to those of ordinary skill in the art without departing from the scope and spirit of the described embodiments. The terminology used herein is chosen to best explain the principles of the embodiments, practical applications, or technical improvements in the market, or to enable other ordinary skilled in the art to understand the embodiments disclosed herein.

1. An electric toothbrush, comprising:
a handle assembly, comprising a measurement module; and
a brush head assembly, provided with a measured block to be identified,
wherein the brush head assembly is in contact with the handle assembly, the measurement module is electrically connected to the measured block, a difference of the measured block forms a signal difference measured by the measurement module, and a type of a brush head is identified according to the signal difference.

2. The electric toothbrush according to claim 1, wherein the identification of the type of the brush head according to the signal difference comprises: a digital signal output by the measurement module is configured to indicate a parameter of the measured block, and the parameter of the measured block is configured to indicate the type of the brush head of the brush head assembly.

3. The electric toothbrush according to claim 2, wherein the measured block is a resistance module, the parameter of the measured block comprises a resistance value of the measured block, and the measurement module comprises a first access terminal for the measured block, a first reference resistor with a known resistance value, a voltage detector, and an analog-to-digital converter; the first access terminal for the measured block is connected in series with the first reference resistor;
the first access terminal for the measured block is configured to connect the measured block in series with the first reference resistor when the brush head assembly is installed on the handle assembly;
the voltage detector is configured to measure a voltage across the first reference resistor to obtain an analog voltage signal after the measured block is connected; and
the analog-to-digital converter is configured to convert the analog voltage signal into a digital voltage signal, the digital voltage signal is configured to indicate the resistance value of the measured block, the resistance value of the measured block is configured to indicate the type of the brush head of the brush head assembly, and the digital signal comprises the digital voltage signal.

4. The electric toothbrush according to claim 2, wherein the measured block is a capacitance module, the parameter of the measured block comprises a capacitance value of the measured block, and the measurement module comprises:
a second access terminal for the measured block, a second reference resistor with a known resistance value, a reference capacitor with a known capacitance value, and a PWM generator; a first terminal of the second reference resistor is connected to an input voltage, a second terminal of the second reference resistor is connected in series with a first terminal of the reference capacitor, a second terminal of the reference capacitor is grounded, the reference capacitor is connected in parallel with the second access terminal for the measured block, and the first terminal of the reference capacitor is connected to an input terminal of the PWM generator, wherein
the second access terminal for the measured block is configured to connect the measured block in parallel with the reference capacitor when the brush head assembly is installed on the handle assembly, so as to change a capacitance at the input terminal of the PWM generator, and the capacitance at the input terminal of the PWM generator is configured to adjust a frequency of a PWM square wave signal output by the PWM generator; and
the PWM generator is configured to output a corresponding PWM square wave signal when the capacitance at the input terminal changes, the PWM square wave signal is configured to indicate the capacitance value of the measured block, the capacitance value of the measured block is configured to indicate the type of the brush head of the brush head assembly, and the digital signal comprises the PWM square wave signal.

5. The electric toothbrush according to claim 2, wherein the handle assembly comprises a spring-type contact module; the spring-type contact module is connected to an access terminal for the measured block in the measurement module, wherein
when the brush head assembly is installed on the handle assembly, the measured block in the brush head assembly is connected to the measurement module by contacting the spring-type contact module.

6. The electric toothbrush according to claim 2, wherein the measured block comprises a magnetic measured block; the handle assembly comprises a magnetic contact module; and the magnetic contact module is connected to an access terminal for the measured block in the measurement module, wherein
the brush head assembly is attracted to the handle assembly through a magnetic force between the magnetic measured block and the magnetic contact module, and the magnetic measured block in the brush head assembly is connected to the measurement module by attracting the magnetic contact module.

7. The electric toothbrush according to claim 1, wherein the handle assembly further comprises a prompt module for sending prompt information, and the prompt information is configured to indicate whether the brush head assembly and the handle assembly are successfully matched.

8. The electric toothbrush according to claim 7, wherein the prompt module is configured to send the prompt information through at least one of light, vibration, and sound.

9. The electric toothbrush according to claim 2, wherein the handle assembly further comprises a control module, and the control module is configured to:
receive the digital signal output by the measurement module, and determine the parameter of the measured block according to the digital signal; and
determine an identification result of the brush head assembly according to the parameter of the measured block, and the identification result characterizes whether the brush head assembly is matched with the handle assembly.

10. The electric toothbrush according to claim 9, wherein determining the identification result of the brush head assembly according to the parameter of the measured block comprises:
determining whether the parameter of the measured block is within a preset parameter range, where the preset parameter range is configured to indicate a parameter range of the measured block in the brush head assembly matched with the handle assembly;
determining that the brush head assembly is matched with the handle assembly in a case where the parameter of the measured block is within the preset parameter range;
determining that the brush head assembly is not matched with the handle assembly in a case where the parameter of the measured block is not within the preset parameter range.

11. The electric toothbrush according to claim 3, wherein the handle assembly comprises a spring-type contact module; the spring-type contact module is connected to an access terminal for the measured block in the measurement module, wherein
when the brush head assembly is installed on the handle assembly, the measured block in the brush head assembly is connected to the measurement module by contacting the spring-type contact module.

12. The electric toothbrush according to claim 3, wherein the measured block comprises a magnetic measured block; the handle assembly comprises a magnetic contact module; and the magnetic contact module is connected to an access terminal for the measured block in the measurement module, wherein
the brush head assembly is attracted to the handle assembly through a magnetic force between the magnetic measured block and the magnetic contact module, and the magnetic measured block in the brush head assembly is connected to the measurement module by attracting the magnetic contact module.

13. The electric toothbrush according to claim 3, wherein the handle assembly further comprises a control module, and the control module is configured to:
receive the digital signal output by the measurement module, and determine the parameter of the measured block according to the digital signal; and
determine an identification result of the brush head assembly according to the parameter of the measured block, and the identification result characterizes whether the brush head assembly is matched with the handle assembly.

14. The electric toothbrush according to claim 4, wherein the handle assembly further comprises a control module, and the control module is configured to:
receive the digital signal output by the measurement module, and determine the parameter of the measured block according to the digital signal; and
determine an identification result of the brush head assembly according to the parameter of the measured block, and the identification result characterizes whether the brush head assembly is matched with the handle assembly.
